(19) United States
(12) Patent Application Publication
(10) Pub. No.: US 2020/0148040 A1
(43) Pub. Date: May 14, 2020

(54) Mounting for a Flat Element of a Sun Protection or Dimming Device, and Sun Protection or Dimming Device

(71) Applicant: Windesa GmbH, Osnabrück (DE)

(72) Inventor: Norbert Borner, Georgsmarienhütte (DE)

(21) Appl. No.: 16/630,861

(22) PCT Filed: Jul. 5, 2018
(86) PCT No.: PCT/EP2018/068280

§ 371 Date: Jan. 14, 2020

(30) Foreign Application Priority Data
Jul. 14, 2017 (DE) 20 2017 104 204.9

(51) Int. Cl. B60J 1/20

(52) U.S. Cl. CPC B60J 1/2011

(57) ABSTRACT

The invention relates to a mounting for a flat element (1) of a sun protection or dimming device, which is provided with a fabric made of a thin fabric material (3) and a peripheral frame (4), which is preferably designed as a clamping frame, in order to cover a window pane (2) of a motor vehicle. The mounting (6) has a receiving area (7) with a receiving opening (8), said receiving area being provided for a section of the frame (4), which is preferably covered by the fabric material (3), and being delimited by a base (9). The mounting (6) has an insert element (11) which faces away from the base (9), has an end (12) remote from the base (9) with a hook-like design, and has a contact surface (13) on the side facing the window pane (2). The base (9) has a support region (14) which is arranged on the base (9) side that transitions into an insert element (11) inner face (16) facing away from the contact surface (13). The invention also relates to a sun protection or dimming device.

The present invention relates to a mounting for a flat element of a sun protection or dimming device, which is provided with a covering made of a thin covering material for covering a windowpane of a motor vehicle and a frame encircling it on the margin, preferably designed as a stretching frame, wherein the mounting comprises a receiving space with a receiving opening, provided for one portion of the frame preferably covered with the covering material and being bounded by a base. Furthermore, the invention relates to a corresponding sunshield or shading device.

Holders are known on the market for the securing of corresponding flat elements of sunshield or shading devices whose base has a receiving space on one side with a receiving opening into which the frame needs to be inserted. An adhesive layer is present on the side of the base opposite the receiving space. With this adhesive layer, the holder is secured to a paneling or frame piece of the motor vehicle. The drawback here is that the surface being glued on is often not adequately pretreated and therefore it is not clean or grease-free. The adhesive layer does not directly provide an adequate adhesion, especially in a heated motor vehicle interior. The flat element of the sunshield device is then inadequately secured. Furthermore, it happens that the adhesive layer cannot be removed without leaving a residue, which may lead to problems when replacing the holder, or in the case of leased vehicles.

It is the object of the present invention to improve a holder of the aforementioned kind or a sunshield or shading device of the aforementioned kind in regard to the mentioned problems.

This object is solved by an article according to claim 1 as well as by an article according to claim 9. Advantageous embodiments of the invention can be taken from the dependent claims referring back to claim 1 and the following specification.

According to the invention, it is proposed to modify a holder of the aforementioned kind such that it comprises an insert element pointing away from the base, whose end distant from the base is fashioned as a hook, and comprising a bearing surface on the side facing toward the windowpane, wherein the base comprises a supporting section, being situated on a side of the base passing into an inner side of the insert element facing away from the bearing surface. Such a holder may be inserted by its insert element in particular between a windowpane seal and a paneling or other functional part of the motor vehicle, preferably a frame, and be secured there at first by virtue of its hook-shaped end. Along the side facing toward the windowpane there is provided a bearing surface for the windowpane seal, generally made from a relatively hard plastic or rubber, which presses the holder in the direction of the paneling or functional part of the vehicle. Now, in order to assure an exact orientation of the receiving opening and the receiving space, a supporting section is provided on the base, which is formed together with the hook-shaped end region of the insert element and optionally other regions of the inner side of the bearing in which the holder is supported. Thanks to the hook-shaped end, the holder does not slip out from the support when pressed upon by a window sealing element or the windowpane seal especially along the insert element in the direction of the base. In combination with the supporting section 14, a fully effective supporting of the flat element is assured even at high speed and with the windows opened.

In addition, an inner bearing surface can be formed on the inner side, which is preferably spaced apart from the supporting section, so that an improved mounting of the holder on the paneling or other functional part of the vehicle is made possible in addition to or together with the hook-shaped end of the insert element.

Advantageously, the insert element is not straight in cross section and is in particular curved outward, i.e., concave in shape with respect to its side facing toward the windowpane. In this way, the hook-shaped end can be moved more easily into the end position of the motor vehicle, especially when the base is formed by a flange substantially making a right angle with the insert element. This is especially advantageous in higher quality vehicles, since damage for example to the sealing material of the window seals is minimized. Furthermore, with this shape a contour of the seal can be modeled which relatively often tapers and runs out in the direction of the base, so that the receiving space and hence the flat element can be positioned more tightly against the windowpane, at the same time having optimal support against the window frame or the corresponding paneling or other functional parts of the motor vehicle. The orientation of the receiving space tightly against the windowpane results in an optimal positioning of the flat element.

Depending on the configuration of the paneling, it may be advantageous for the insert element to have more than one web forming a hook, forming an angle≤90° between the web thereof preferably situated at the end of the insert element and the inner side, especially to assist the hook function.

According to another advantageous embodiment of the invention, the outer surface of one wall of the receiving space facing toward the windowpane is curved in cross section, wherein the wall becomes thinner in the direction of the end facing away from the base. Hence, the thinning end is lifted off from any adjacent windowpane surfaces, which is advantageous for its arrangement in the upper frame regions of the window, since the windowpane then impinges less against the end of the holder when closed.

Advantageously, the receiving space is bounded by walls that are arranged on the base and whose mutually facing surfaces are formed predominantly parallel to each other. This makes it easier to remove the frame elements without the holder being pulled out from its bearing seat between the windowpane seal and the paneling or the like.

In particular, the holder is substantially h-shaped in cross section, so that an easily explained handling of the holder with a distinct receiver and a clearly recognizable insert element is created. Such a shape is especially suited to forming the holder by an extruded profile, preferably of plastic. Such a profile can be easily cut to length and be produced with simple extrusion dies.

After cutting to length, sharp points or corners of the profile on the walls of the receiving space can be bent over or rounded in order to prevent a damaging of the covering material of the flat element.

The above stated object is likewise solved by a sunshield or shading device with a flat element, which is provided with a covering made of a thin covering material for covering a windowpane of a motor vehicle and a frame encircling it on the margin, preferably designed as a stretching frame, this sunshield or shading device having at least one holder as described above or in the following.

Further benefits and details of the invention will be found in the following description of the figures. Schematically shown is in:

FIG. 1 an article according to the invention in a perspective view,

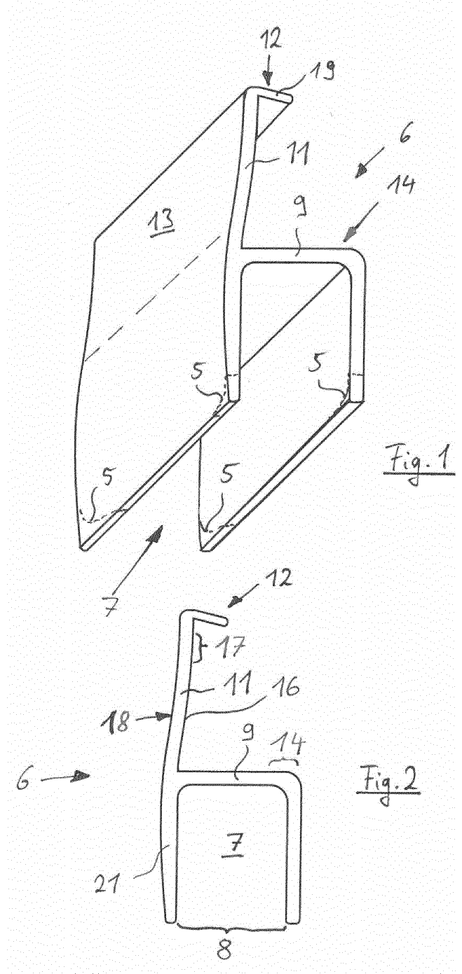

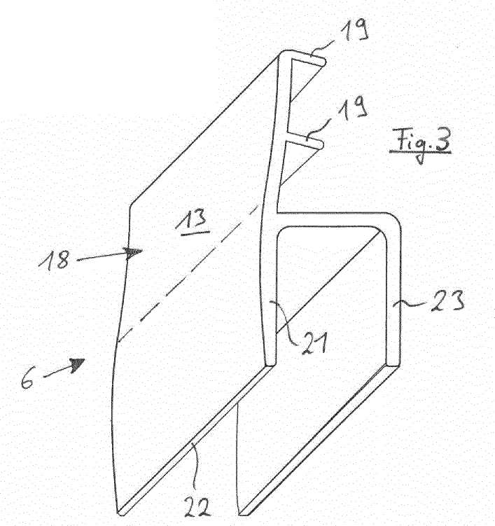

FIG. 2 the article of FIG. 1 in a cross section,

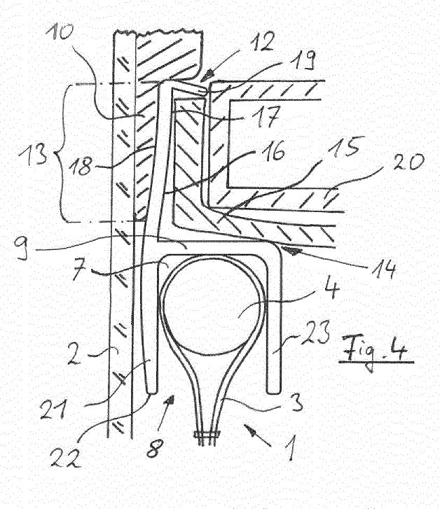

FIG. 3 another article according to the invention in a perspective view,

FIG. 4 a portion of the sunshield or shading device according to the invention in an installed situation.

Individual technical features of the following described exemplary embodiment may also be combined in combination with already described exemplary embodiments and the features of the independent claims and any other claims to produce objects according to the invention. Functionally equivalent elements are given the same reference numbers, where feasible.

A holder 6 according to the invention for a flat element 1 (see FIG. 4) of a sunshield or shading device, which is provided with a covering made of a thin covering material 3 for covering a windowpane 2 of a motor vehicle and a frame 4 encircling it on the margin, preferably designed as a stretching frame, comprises a receiving space 7 with a receiving opening 8, provided for one portion of the frame 4 preferably covered with the covering material 3 and being bounded by a base 9 (FIG. 1). The holder comprises an insert element 11 pointing away from the base 9, whose end 12 distant from the base 9 is fashioned as a hook, and comprising a bearing surface 13 on the side facing toward the windowpane 2, wherein the base comprises a supporting section 14, being situated on a side of the base 9 passing into an inner side 16 of the insert element 11 facing away from the bearing surface 13. Thanks to these regions (bearing surface 13, supporting section 14, end 12), also disclosed in particular in FIG. 2, a kind of triangular configuration is obviously produced, which affords an optimal support, optionally supplemented by an inner bearing surface 17 of the insert element. This is also shown in FIG. 4. The inner side 16 of the insert element 11 forms here the inner bearing surface 17, which is spaced apart in particular from the supporting section 14 (FIG. 2).

In the exemplary embodiment of FIG. 3, webs 19 are arranged on the inner side 16 forming at least one hook with the other insert element 11, by which the insert element 11 can be adapted to different paneling structures. In particular, the lower web 19 in FIG. 3, as well as the upper web 19, can be provided with an indentation on the side facing away from the base, in the form of a one-sided sufficiently stiff film hinge, allowing a certain flexibility of the connection of the web to the other insert element, so that it is more easily inserted into the region shown in FIG. 4, but at the same time it can also bend back into the position shown in FIG. 3.

Especially in FIGS. 2 and 4, and also in FIGS. 1 and 3, the outer surface of a wall 21 of the receiving space 7 facing toward the windowpane is curved in cross section, the thickness of the wall 21 becoming thinner in the direction of the end facing away from the base 9, in order for this end not to contact the wall 21 in situations when the free end of a windowpane 2 runs out toward the frame. The pane is further guided into the desired position by the rounded outer surface of the wall 21.

The depicted holders 6 are formed as extruded profiles and are substantially h-shaped, so that it is easily possible to create the holder. The broken lines in FIG. 1 show how the edge would appear in the case of rounded corners.

In particular, the holder 6 according to FIG. 4 is provided with a non-straight configuration in the represented cross section shape of the insert element 11, the side 18 facing toward the windowpane 2 being concave in form. This allows for the downward tapering trend of the windowpane seal 10 in the plane of the drawing and at the same time ensures sufficiently large pressure in the direction of the supporting section 14 also in the end region of the windowpane seal 10 thanks to the following bearing surface 13. Preferably, the bearing surface is formed along the predominant surface (>50%) of the side of the insert element facing toward the windowpane. Since at the same time the hook-shaped end 12 is secured at a paneling piece 15, covering a frame 20 of the motor vehicle, an exactly fitted positioning of the holder 6 and an in cross section nearly parallel orientation of the inner walls of the walls 21 and 23 of the receiving space 7 to the windowpane 2 are achieved. By varying the curvature of the insert element 17 (in cross section) and its length, and the width of the base 9, the holder according to the invention and hence the sunshield or shading device according to the invention can be easily adapted to different vehicle models and types.

What is claimed is:

1.-9. (canceled)

10. A holder for a flat element of a sunshield or shading device, the sunshield or shading device comprising a covering made of a thin covering material for covering a windowpane of a motor vehicle and further comprising a frame encircling the covering on a margin of the covering, wherein the holder comprises:
a base;
a receiving space delimited by the base and comprising a receiving opening configured to receive a portion of the frame;
an insert element connected to the base and pointing away from the base;
the insert element comprising an end distant from the base, wherein the end is formed as a hook;
the insert element comprising an outer side facing toward the windowpane and further comprising an inner side facing away from the windowpane, wherein the outer side facing toward the windowpane comprises an outer bearing surface;
the base comprising a supporting section disposed on a side of the base passing into the inner side of the insert element.

11. The holder according to claim 10, wherein the inner side of the insert element comprises an inner bearing surface.

12. The holder according to claim 11, wherein the inner bearing surface is spaced apart from the supporting section of the base.

13. The holder according to claim 10, wherein the insert element is not straight in cross section.

14. The holder according to claim 13, wherein the outer side of the insert element is concave.

15. The holder according to claim 10, further comprising at least one web disposed on the inner side of the insert element, wherein the at least one web forms a hook together with the inner side of the insert element.

16. The holder according to claim 10, wherein the receiving space is further delimited by a wall connected to the base, wherein the wall faces toward the windowpane and comprises an outer surface facing toward the windowpane, wherein the outer surface is curved in cross section, wherein the wall has an end facing away from the base and the wall becomes thinner toward the end of the wall.

17. The holder according to claim 10, wherein the receiving space is further delimited by walls connected to the base, wherein the walls have mutually facing surfaces that are predominantly parallel to each other.

18. The holder according to claim 10, wherein the holder is substantially h-shaped in cross section.

19. The holder according to claim 18, wherein the holder is formed by an extruded profile.

20. A sunshield or shading device comprising:
a flat element comprising a covering made of a thin covering material for covering a windowpane of a motor vehicle and further comprising a frame encircling the covering on a margin of the covering;
at least one holder according to claim 10.

21. The sunshield or shading device according to claim 20, wherein the frame is a stretching frame.

22. The sunshield or shading device according to claim 20, wherein the frame is covered by the covering material.
